(19) United States
(12) Patent Application Publication
(10) Pub. No.: US 2006/0139832 A1
(43) Pub. Date: Jun. 29, 2006

(54) Common mode surge protection filter

(75) Inventors: Kirk Yates, Loomis, CA (US); Andrew Michael Cherniski, Rescue, CA (US); Kenneth Viloria, Citrus Heights, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/026,174

(22) Filed: Dec. 29, 2004

(51) Int. Cl. H02H 9/00

(52) U.S. Cl. 361/111

(57) ABSTRACT

A filter circuit in a surge protection device comprises a Y-capacitor, a first metal oxide varistor (MOV) coupled between a first line and the Y-capacitor, and a second metal oxide varistor (MOV) coupled between a second line and the Y-capacitor.

### BACKGROUND OF THE INVENTION

Common mode high voltage transients are typically protected by bulk capacitance, Y-capacitors, gas discharge tubes (GDT), or a combination of metal oxide varistors (MOVs) and GDTs. A problem with usage of bulk capacitance, such as Y-capacitors, for common mode protection is susceptibility to failing United Laboratories, Inc. (UL) current leakage testing. The higher the capacitance level that is sufficient to absorb the higher energies, the greater the difficulty of current leakage becomes.

The problem with gas discharge tubes (GDT) is limited life during high energy transients. GDT implementations eventually fail leaving a device unprotected.

Metal oxide varistors (MOVs) alone are not used for common mode protection due to regulatory high potential (Hi-pot) specifications. Thus, MOVs are commonly used in combination with GDTs or used in differential mode alone.

### SUMMARY

In accordance with a surge protection device, an embodiment of a filter circuit comprises a Y-capacitor, a first metal oxide varistor (MOV) coupled between a first line and the Y-capacitor, and a second metal oxide varistor (MOV) coupled between a second line and the Y-capacitor.

### BRIEF DESCRIPTION OF THE DRAWINGS

Embodiments of the invention relating to both structure and method of operation, may best be understood by referring to the following description and accompanying drawings whereby:

FIG. 1 is a schematic circuit diagram illustrating an embodiment of a filter circuit;

FIGS. 2A and 2B are schematic circuit diagrams illustrating embodiments of a filter circuit further including thermal protection;

FIG. 3 is a schematic block diagram showing an embodiment of a surge protection device that incorporates a common mode surge protection filter;

FIG. 4 is a schematic block diagram depicting an embodiment of an electronic system that incorporates a common mode surge protection filter; and

FIG. 5 is a graph illustrating a relationship of Y-capacitor size to transient voltage for common mode surge protection filter circuits such as those shown in FIGS. 1, 2A, 2B, 3, and 4.

### DETAILED DESCRIPTION

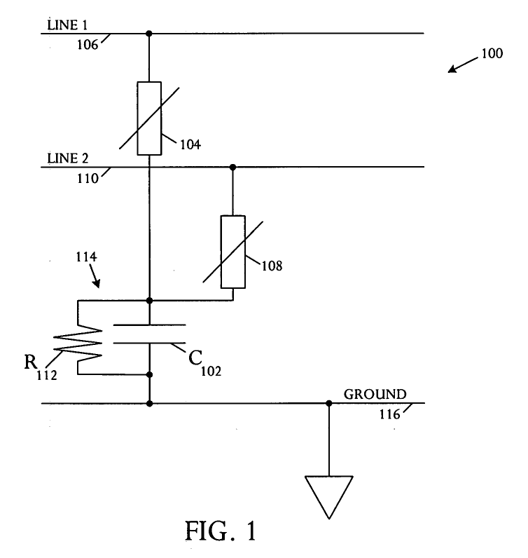

Referring to FIG. 1, a schematic circuit diagram illustrates an embodiment of a filter circuit 100 for common mode surge protection. The filter circuit 100 comprises a Y-capacitor 102, a first metal oxide varistor (MOV) 104 coupled between a first line 106 and the Y-capacitor 102, and a second metal oxide varistor (MOV) 108 coupled between a second line 110 and the Y-capacitor 102. The circuit 100 includes a metal oxide varistor (MOV) 104, 108 on each inlet line 106, 110. Both metal oxide varistors 104, 108 terminate onto the Y-capacitor 102.

A resistor 112 is coupled in parallel with the Y-capacitor 102 and the resulting resistor-capacitor (RC) parallel circuit 114 is connected to ground 116. The Y-capacitor 102 has a resistor R 112 in parallel to assist in discharging the Y-capacitor 102 upon the occurrence of any transient voltage spike or surge that charges the Y-capacitor 102. Both the Y-capacitor 102 and the resistor R 112 terminate to chassis ground 116.

The Y-capacitor 102 protects the metal oxide varistors (MOVs) 104, 108 from large direct current (DC) voltages such as voltages occurring during high potential testing, and permits the metal oxide varistors to discharge during high frequency, high energy transients such as transients occurring during electrical storms and inductive motor start-ups.

The first 106 and second 110 lines are typically first and second voltage inlet lines, respectively. The voltage inlet lines are otherwise termed a line voltage or active line, and a neutral line.

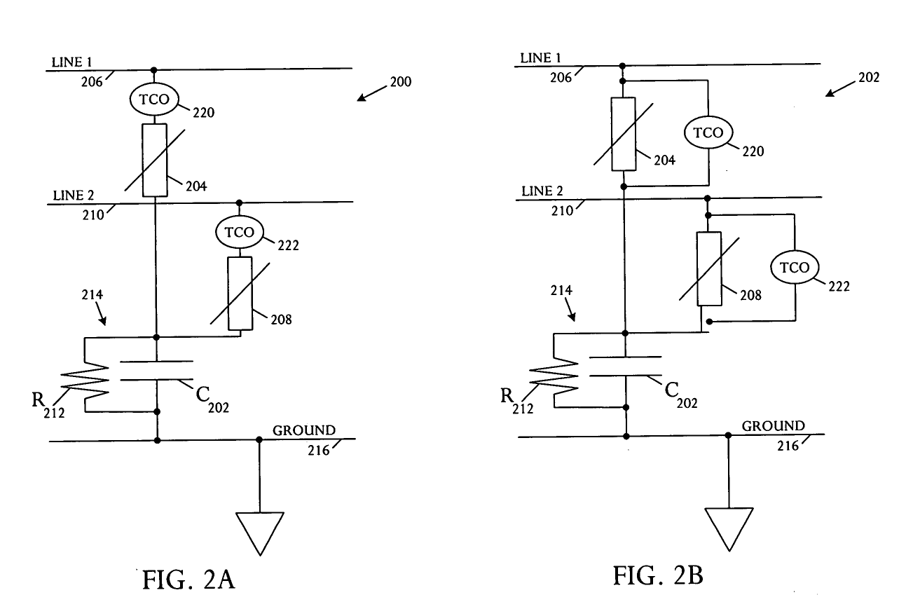

Referring to FIGS. 2A and 2B, schematic block diagrams illustrate another embodiment of a filter circuit 200 for common mode surge protection that further includes thermal protection. In the illustrative common mode surge protection filter circuit 200, the RC circuit 214 comprises a bulk Y capacitor 202 and the resistor 212 coupled in parallel with the RC circuit 214 coupled to ground. A first metal oxide varistor (MOV) 204 is coupled between the first line 206 and the RC circuit 214 and the second metal oxide varistor (MOV) 208 is coupled between the second line 210 and the RC circuit 214. A first thermal cut-off 218 can be coupled to the first MOV 204, for example between the first line 206 and the first MOV 208. A second thermal cut-off 220 may be coupled to the second MOV 208, between the second line 210 and the second MOV 208.

FIG. 2A depicts placement of the thermal cut-offs 220, 222 in series with the MOVs 204, 208. FIG. 2B shows placement of the thermal cut-offs 220, 222 in parallel with the MOVs 204, 208. Inclusion of the thermal cut-offs 220, 222 protects from thermal events that may result from current flowing through the MOVs 204, 208. Thermal cut-offs (TCOs) are available in multiple various opening temperatures. TCOs are activated by a combination of conducted, convected, and radiated heat from the MOVs.

In a further additional embodiment, the metal oxide varistors 204 and 208 may be thermally-protected metal oxide varistors (TMOVs). In some embodiments, internally thermally protected MOVs include a thermal fuse element inside an epoxy coating of a metal oxide varistor, in close contact with an internal ceramic disk.

Conventional surge protection circuits sometimes use bulk Y-capacitors but in a configuration that may lead to higher leakage currents, thereby risking failure of current leakage testing specifications. Generally, the higher the capacitance of the bulk capacitor, the more leakage current measured. Other conventional designs use gas discharge tubes (GDT), an implementation with limited reliability due to weakening of the device with each incurred transient. Some conventional designs use metal oxide varistors (MOVs) in series with GDTs to protect the GDTs from catastrophic failure, an implementation that adds cost and bulk.

Metal oxide varistors (MOVs) are a common type of varistor that typically contain zinc oxide grains in a matrix of other metal oxides. The zinc and metal oxides are sandwiched between two electrodes. The boundary between adjacent metal oxide grains forms a diode junction that constrains current to flow in only one direction. The randomly-oriented metal oxide grains form a mass functionally analogous to a network of back-to-back diode pairs with the pairs in parallel with many other pairs. Application of a small to moderate voltage across the electrodes causes only a small current to flow, causing a reverse leakage through the diode junctions. Application of a large voltage causes the diode junctions to break down due to avalanche effect and large current flows. A highly nonlinear current-voltage characteristic results with the MOV having a high resistance at low voltages and a low resistance at high voltages.

The metal oxide varistor (MOV), Y-capacitor, and resistor configurations depicted in FIGS. 1, 2A, and 2B are a reliable, low leakage current filter that protects downstream components from high energy transients induced during common mode, high energy testing. The MOV, Y-capacitor, resistor configuration is less susceptible to catastrophic failure than gas discharge tubes (GDT). The MOV, Y-capacitor, resistor filter is lower in cost than alternative such as GDT/MOV circuits and uses less space than other designs such as bulk capacitance or MOV/GDT circuits. The MOV, Y-capacitor, resistor configuration also reduces the amount of leakage current compared to use of bulk capacitors alone.

The illustrative common mode surge protection filter circuits 100, 200 facilitate passage of various United Laboratories (UL) tests including high potential (Hi-pot) testing, current leakage testing, Bi-wave testing, and Ring wave testing. The Hi-pot test involves application of a high voltage to a device to determine status of electrical insulation and may otherwise be termed voltage withstand testing, dielectric strength testing, and insulation breakdown testing.

Current leakage testing involves measurement of continuous leakage currents from an enclosure back to the system. Typically tests are performed on various combinations of open and closed earth conductors, with normal and reversed polarity conditions, and with the neutral conductor open and closed.

Bi-wave testing involves measurement of surge voltage in response to a bi-wave or two waves combined including a voltage in one time frame and current in a second time frame. In one example, an applied impulse is 6000 volts at a rise time of 1.2 microseconds (μs) and 50 μs to decay to half power followed by 3000 amperes at a rise time of 8 μs and 20 μs to decay to half power.

The ring wave surge test simulates surges resulting from switching events. For example, a 100 kHz sinusoidal wave test voltage with amplitude between 2 and 6 kV and current capabilities of 200 and 500 amperes may be applied.

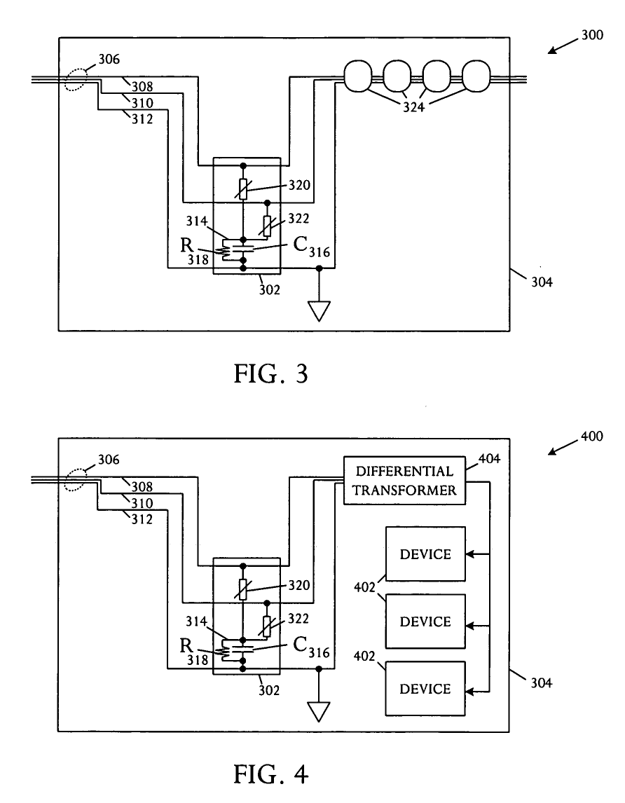

Referring to FIG. 3, a schematic block diagram illustrates an embodiment of an electronic equipment unit 300 that incorporates a common mode surge protection filter 302. The electronic equipment unit 300 comprises a chassis 304 and an electrical wire 306 supplying power to the chassis 304. The electrical wire 306 includes a line voltage line 308, a neutral line 310, and a ground line 312. The common mode surge protection filter circuit 302 is coupled to the electrical wire 306 and further comprises an RC circuit 314 with a bulk Y capacitor 316 and a resistor 318 coupled in parallel. The RC circuit 314 is coupled to the ground line 312. First 320 and second 322 metal oxide varistors (MOV) are respectively coupled between the line voltage 308 and neutral 310 lines and the RC circuit 314.

The electronic equipment unit 300 may further include at least one outlet 324 coupled to the electrical wire 306 and formed into the chassis 304. In various embodiments, the electronic equipment unit 300 can be a surge suppression device. Several examples of surge suppression devices 300 are surge suppression receptacles, entertainment power centers, rack mount surge suppressors, whole-house surge suppressors, programmable power control systems, plug-in noise filters, uninterruptible power supplies (UPS), and power strips.

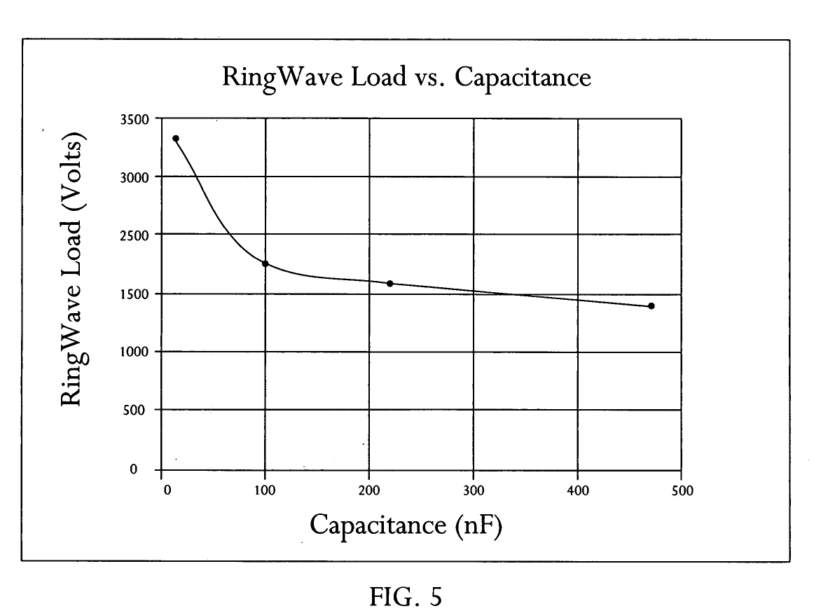

Referring to FIG. 4, an electronic equipment unit 400 may further include at least one electronic device 402 coupled to the electrical wire 306 and contained within the chassis 304. In various embodiments, the electronic equipment unit 400 may be an electronic system. Various electronic systems 400 and associated devices 402 include computers, storage systems, communication systems, consumer electronics units, and entertainment systems.

The electronic systems 400 may further include a differential transformer 404 coupled between the common mode surge protection filter circuit 302 and the at least one electronic device 402.

In some embodiments of the surge suppression devices 300 and electronic systems 400, the first 320 and second 322 MOVs may be thermally-protected metal oxide varistors (TMOVs). Similarly, first and second thermal cut-offs may be coupled between the line voltage and neutral lines and the first and second MOVs, respectively, as is shown in FIG. 2.

Referring to FIG. 5, a graph illustrates a relationship of Y-capacitor size to transient voltage for common mode surge protection filter circuits such as those shown in FIGS. 1, 2A, 2B, 3, and 4. Illustratively, bulk or Y-capacitor values greater than about 100 nano-ferads (nF) attain suitable reduction in transient voltage. For Y-capacitor values less than about 100 nF, transient voltages begin to increase asymptotically. In a particular example, a capacitance of 470 nF corresponds to a transient voltage of about 1400 volts (V), 220 nF capacitance relates to a 1600 V transient, 100 nF yields 1750 volts (V), and 15 nF capacitance corresponds to 3300 volts (V).

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. For example, although the filter is described for usage with particular examples of electronic equipment units and electronic systems, the filter may be implemented in any suitable electronic equipment units a and electronic systems.

What is claimed is:

1. A common mode surge protection filter circuit comprising:
an RC circuit comprising a bulk Y capacitor and a resistor coupled in parallel, the RC circuit coupled to ground;
a first metal oxide varistor (MOV) coupled between a first line and the RC circuit; and
a second metal oxide varistor (MOV) coupled between a second line and the RC circuit.

2. The circuit according to claim 1 wherein:
the RC circuit is coupled to ground.

3. The circuit according to claim 2 wherein:
the first MOV is coupled to a first voltage inlet line; and
the second MOV is coupled to a second voltage inlet line.

4. The circuit according to claim 2 wherein:
the first MOV is coupled to an active line; and
the second MOV is coupled to a neutral line.

5. The circuit according to claim 1 further comprising:
a first thermal cut-off coupled to the first MOV; and
a second thermal cut-off coupled to the second MOV.

6. The circuit according to claim 1 wherein:
the first MOV and the second MOV are thermally-protected metal oxide varistors (TMOVs).

7. A filter circuit comprising:
a Y-capacitor;
a first metal oxide varistor (MOV) coupled between a first line and the Y-capacitor; and
a second metal oxide varistor (MOV) coupled between a second line and the Y-capacitor.

8. The circuit according to claim 7 further comprising:
a resistor coupled in parallel with the Y-capacitor.

9. The circuit according to claim 7 further comprising:
a ground connection to the Y-capacitor.

10. The circuit according to claim 7 wherein:
the first line is a first voltage inlet line; and
the second line is a second voltage inlet line.

11. The circuit according to claim 7 wherein:
the circuit is a common mode surge protection filter circuit.

12. The circuit according to claim 7 further comprising:
a first thermal cut-off coupled to the first MOV; and
a second thermal cut-off coupled to the second MOV.

13. The circuit according to claim 7 wherein:
the first MOV and the second MOV are thermally-protected metal oxide varistors (TMOVs).

14. An electronic equipment unit comprising:
a chassis;
an electrical wire supplying the chassis and further comprising a line voltage line, a neutral line, and a ground line; and
a common mode surge protection filter circuit coupled to the electrical wire further comprising:
an RC circuit comprising a bulk Y capacitor and a resistor coupled in parallel, the RC circuit coupled to the ground line;
a first metal oxide varistor (MOV) coupled between the line voltage line and the RC circuit; and
a second metal oxide varistor (MOV) coupled between the neutral line and the RC circuit.

15. The unit according to claim 14 further comprising:
a first thermal cut-off coupled between the line voltage line and the first MOV; and
a second thermal cut-off coupled between the neutral line and the second MOV.

16. The unit according to claim 14 wherein:
the first MOV and the second MOV are thermally-protected metal oxide varistors (TMOVs).

17. The unit according to claim 14 further comprising:
at least one outlet coupled to the electrical wire and formed into the chassis, wherein the electronic equipment unit is a surge suppression device selected from among a group consisting of surge suppression receptacles, entertainment power centers, rack mount surge suppressors, whole-house surge suppressors, programmable power control systems, plug-in noise filters, uninterruptible power supplies (UPS), and power strips.

18. The unit according to claim 14 further comprising:
at least one electronic device coupled to the electrical wire and contained within the chassis, wherein the electronic equipment unit is an electronic system selected from among a group consisting of computers, storage systems, communication systems, consumer electronics units, and entertainment systems.

19. The unit according to claim 18 further comprising:
a differential transformer coupled between the common mode surge protection filter circuit and the at least one electronic device.
